(19) United States
(12) Patent Application Publication
(10) Pub. No.: US 2017/0353141 A1
(43) Pub. Date: Dec. 7, 2017

(54) Torque Regulating Device, Electric Drive and Method for Torque Regulation

(71) Applicant: Trafag AG, Bubikon (CH)

(72) Inventor: Christoph Schanz, Rickenhausen (DE)

(73) Assignee: Trafag AG

(21) Appl. No.: 15/612,007

(22) Filed: Jun. 2, 2017

(30) Foreign Application Priority Data
Jun. 2, 2016 (DE) 10 2016 110 260.1
Nov. 22, 2016 (DE) 10 2016 122 547.9

(51) Int. Cl. H02P 29/032; H02K 11/24; G01L 3/10

(52) U.S. Cl. CPC H02P 29/032; G01L 3/105; H02K 11/24; G01L 3/102; H02P 2205/05

(57) ABSTRACT

The invention relates to a torque regulating device (20) for regulating the output power and/or the torque of an electric drive (10) having an electric motor (12) with a stator and a rotor and preferably an output shaft (14) connected to the rotor for joint rotation. In order to enable a more accurate regulation with, at the same time, a possibility for implementing an improved safety monitoring of the electric drive (14), there are provided a torque sensor (26) for measuring a torque acting between the stator and the rotor, in particular by measuring on the output shaft (14), and a control system (24) which is connected to the torque sensor (26) and is configured to control the electric motor (12) in accordance with the torque measured by the torque sensor (26). Further, a corresponding regulating method and an advantageous torque sensor assembly for use in the device and in the method are proposed.

### CROSS REFERENCE TO RELATED APPLICATIONS

This application claims priority to German Patent Application No. 10 2016 110 260.1, filed on Jun. 2, 2016, and German Patent Application No. 10 2016 122 547.9, filed on Nov. 22, 2016, the entire disclosures of which are incorporated herein by reference.

### TECHNICAL FIED

The invention relates to a device and a method for regulating the output power and/or the torque of an electric drive having an electric motor with a stator and a rotor and preferably an output shaft connected to the rotor for joint rotation. Further, the invention relates to a torque sensor assembly that can be used for such a device and method.

### BACKGROUND ART

In power electronic systems for electric drives that were previously commercially available, the power consumption of an electric motor can be measured relatively accurately by measuring the phase currents and phase voltages. The output power can be calculated by corresponding models pertaining to the degree of efficiency and various dependencies (temperature dependence, ageing behavior . . . ). With these quantities, electric motors can be regulated to a specific torque with a known angular velocity of the axis. Such electric drives and their torque regulation devices can be found, for example, in commercially available primary electric drives for electric vehicles.

One example for a known regulation system of an electric drive in the field of electric steering systems can be found in US2005037884A1.

### SUMMARY

The invention has set itself the task of improving such devices and methods for torque regulation and/or the regulation of the power of electric drives with regard to the accuracy of the output torque or of the output power and/or with regard to safety aspects.

This object is achieved by a device and a method according to the independent claims. An electric drive provided with such a device is the subject matter of the further independent claim.

Advantageous embodiments are the subject matter of the dependent claims. The invention provides a torque regulating device for regulating the output power and/or the torque of an electric drive having an electric motor with a stator and a rotor, comprising: a torque sensor for measuring a torque between the stator and the rotor, and a control system which is connected to the torque sensor and is configured to control the electric motor in accordance with the torque measured by the torque sensor. Preferably, the torque regulating device for regulating an electric drive is formed, which has an output shaft connected to the rotor for joint rotation, the torque being measured on the output shaft. In alternative embodiments, in particular in the case of an external rotor motor, for example, the torque may also be measured on a component connected to the stator. For example, a supporting force could be measured on a fastening component supporting the stator, and the torque could be obtained therefrom.

A component connected to the rotor is to be understood to be a component via which forces are to be transmitted from the rotor onto a driven unit. The component may be formed separately from the rotor and merely coupled with it, or also be integrally formed with the rotor. An output shaft of the electric motor is a preferred embodiment of such a component connected to the rotor.

A component connected to the stator is to be understood to be a component via which the forces for holding the stator are to be transmitted. The component may be formed separately from the stator and merely coupled with it, or also be integrally formed with the stator.

In particular, it is possible to provide a torque-regulated electric motor with the invention, which is regulated not by means of the voltage/current, but by means of an active sensor element.

A preferred embodiment of the invention is characterized by a rotation rate sensor for measuring the rotation rate of the output shaft, the control system being connected to the rotation rate sensor and configured to control the electric motor in accordance with the torque measured by the torque sensor and the rotation rate determined by the rotation rate sensor.

It is preferred that the control system is configured to determine the output power of the electric drive from the torque and the rotation rate and to control the electric motor in accordance with the determined output power. It is preferred that the control system is configured for monitoring the power output of the electric drive.

It is preferred that the control system is configured to control and/or monitor the electric drive in accordance with an input power determined from an input current and an input voltage, and an output power determined from the torque, and a nominal power.

In the case of electromobility, in particular, there is a requirement (SIL2 according to EN61508 and/or Performance Level d according to ISO 13849-1) that the output power of the electric motor is monitored. This can be done by means of voltage/current. However, this is possible with much greater accuracy by immediate monitoring via direct sensors on the output shaft, as proposed in the invention. The idea according to the invention has particular advantages if the electric drive is regulated with respect to the torque for torque vectoring. In such a case, an active sensor element, as proposed in the invention, is very advantageous because it is not feasible to both regulate current/voltage and also use this quantity for safety monitoring as well.

It is preferred that the torque sensor is an inductive contactless sensor for inductive torque detection directly on the component, in particular the output shaft, by means of alternating magnetic fields. Such sensors can be used very easily on the output shaft or another component (e.g. on a support for the stator), wherein the component, such as the output shaft, may also remain unchanged and no active elements are required in the co-rotating system. The contactless measurement. takes place without any friction losses and is substantially maintenance-free. In one embodiment of the invention, a torque sensor assembly for measuring a torque on a rotary shaft is used, comprising: the rotary shaft, and a torque sensor for inductively measuring the torque of the rotary shaft by means of alternating magnetic fields, and an evaluation device for evaluating the signal of the torque sensor, wherein the rotary shaft has, on a circumferential region acquired by the torque sensor, a surface mark that rotates about the rotary axis when the rotary shaft rotates and causes a change in the signal of the torque sensor upon passing the torque sensor, wherein the evaluation unit is configured for determining a rotation rate of the shaft from the periodic change of the signal of the torque sensor. With such a torque sensor assembly, both the torque of the rotary shaft (e.g. of the output shaft) and its rotation rate can be determined simultaneously with a single signal. Thus, the mechanical power on the rotary shaft can be directly determined with a single signal. This is of major interest for regulating electric drives, of course, but may also be used in other applications. For example, the mechanical power could be measured directly on an output shaft in various applications (passenger vehicles; heavy goods vehicles; ships; machines; aircraft; vehicles). In a preferred embodiment of the invention, the torque sensor assembly is configured for use in a torque regulation system according to any one of the embodiments explained above, wherein the output shaft is the rotary shaft of the torque sensor assembly to be measured.

It is preferred that the surface mark comprises an axially extending flattened portion, notch or raised portion on the surface of the circumferential region. It is preferred that the surface mark has a predefined extent in the circumferential direction, wherein the evaluation device is configured for determining a rotary speed from the length of a signal change caused in the signal of the torque sensor by the surface mark.

According to another aspect, the invention provides a torque regulating device as explained above, comprising a torque sensor assembly according to any one of the embodiments explained above.

According to another aspect, the invention provides an electric drive, comprising a torque regulating device and/or a torque sensor assembly according to any one of the inventive or advantageous embodiments.

According to another aspect, the invention provides a method for regulating the output power and/or the torque of an electric drive having an electric motor with a stator and a rotor and an output shaft connected to the rotor for joint rotation, comprising: measuring a torque on the output shaft by means of a torque sensor and controlling the electric motor in accordance with the torque measured by the torque sensor.

A preferred embodiment of the method comprises: measuring the rotation rate of the output shaft, and controlling the electric motor in accordance with the torque measured by the torque sensor and the rotation rate determined by the rotation rate sensor.

A preferred embodiment of the method comprises: determining the output power of the electric drive from the torque and the rotation rate, and controlling the electric motor in accordance with the determined output power.

A preferred embodiment of the method comprises: monitoring the power output of the electric drive by means of the output power, the input power determined from an input current and an input voltage, and a nominal power.

A preferred embodiment of the method comprises: contactless inductive measuring of the torque on the output shaft by means of alternating magnetic fields.

A preferred embodiment of the method comprises: using an output shaft having, on a circumferential region acquired by the torque sensor, a surface mark that rotates about the rotary axis when the output shaft rotates and causes a change in the signal of the torque sensor upon passing the torque sensor, and determining the rotation rate of the output shaft from the period of the change of the signal of the torque sensor.

A preferred embodiment of the method comprises: providing an axially extending flattened portion, notch or raised portion on the surface of the circumferential region for forming the surface mark.

A preferred embodiment of the method comprises: providing the surface mark with a predefined extent in the circumferential direction, and determining the rotary speed from the length of a signal change caused in the signal of the torque sensor by the surface mark.

In particular, the invention relates to a torque regulation of an electric motor or for an electric motor.

A preferred embodiment relates to a torque regulation of an electric motor by measuring the output power by means of a torque sensor and a rotation rate sensor. Thus, a very accurate regulation is possible.

The torque regulating device according to the invention of the embodiments thereof are preferably configured for carrying out the method according to any one of the above-mentioned embodiments. In particular, the method can be carried out with such a device.

Preferably, the device and method additionally or alternatively include a monitoring of the motor power output as a safety monitoring by means of the input power (voltage, current).

Thus, a very good safety monitoring for torque-regulated electric motors is possible. By drawing upon the actual output power, which is determined by means of the measured torque and the measured rotation rate, as a regulation input variable, the voltage and the current can be used as other quantities for other tasks, in particular for safety monitoring. Furthermore, the degree of efficiency and the power loss can be determined by a comparison, even without any detours via the consideration of other parameters (such as environmental conditions).

An advantageous application is explained below: By using electric motors in electromobility, their function is considered critical with respect to safety, i.e. the power output should be monitored in a safety function. This monitoring can be implemented by means of current and voltage. In an active regulation of the output power of the electric motor (torque vectoring, anti-slip control . . . ) on the shaft of a drive unit, a second measuring device is required for active regulation in order to continue to be able to use the function monitoring by means of voltage and current as an independent quantity outside the control system. According to an advantageous embodiment of the invention, a direct measurement of the torque and, optionally, of the rotation rate on the output shaft is proposed.

One aspect of the invention relates to a torque sensor on the output shaft of an electric motor for the measurement of the torque. Preferably, the torque sensor is used for regulating or for fulfilling a safety characteristic. This would then be applications produced due to the general description—thus, we are focusing not on a single application, but on everything that can be done with a torque sensor on the output.

Preferably, the torque sensor is an inductive sensor. However, the torque sensor may function in accordance with every possible principle of measuring the torque on the shaft.

Of course, a generator may also be provided instead of the electric motor. Exemplary embodiments of the invention will be explained in more detail below with reference to the attached drawings.

### BRIEF DESCRIPTION OF DRAWINGS

FIG. 1 shows a schematic representation of an electric drive with an electric motor;

FIG. 2 shows the electric drive of FIG. 1 with a torque regulating device for regulating the torque and/or the outputted power of the electric motor;

FIG. 3 shows a schematic representation of a torque sensor assembly for use in the torque regulating device according to FIG. 2;

FIG. 4 shows a graph of the signal of a torque sensor of the torque sensor assembly of FIG. 3 over time;

FIG. 5 shows a schematic representation of another embodiment of the torque sensor assembly; and

FIG. 6 shows a graph of the signal of a torque sensor of the torque sensor assembly of FIG. 3 over time.

### DETAILED DESCRIPTION

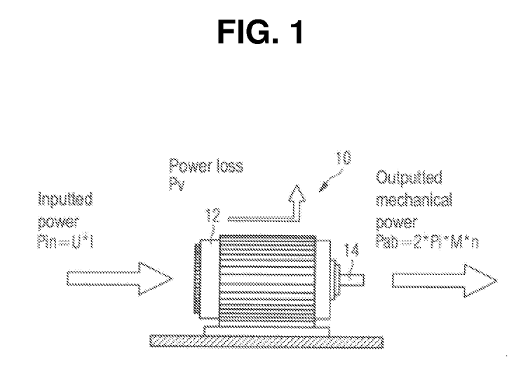

FIG. 1 schematically illustrates an electric drive 10, which is in this case formed by an electric motor 12 with a stator and a rotor (not shown in detail, well known). A shaft of the rotor forms an output shaft 14 of the electric drive 10. In other embodiments (not shown), the output shaft 14 is a shaft coupled to the shaft of the rotor for joint rotation, e.g. an end shaft of a motor transmission provided on the electric motor.

In electric motors, the drive power P has so far only been determined via the voltage U and the current I with P=U*I. However, the input power Pᵢₙ=U*I is thus determined. In order to determine the outputted power, the power loss Pᵥ would have to be taken into account by means of modelling calculations.

For the mechanical outputted power P_{ab}, the following applies: P_{ab}=2*Pi*M*n, wherein M denotes the torque on the output shaft 12 and n the rotation rate of the output shaft 14. If the electric drive 10 was previously to be regulated in such a way that a constant output torque M was outputted, then the input power was correspondingly regulated by means of the measured voltage U and the measured current I.

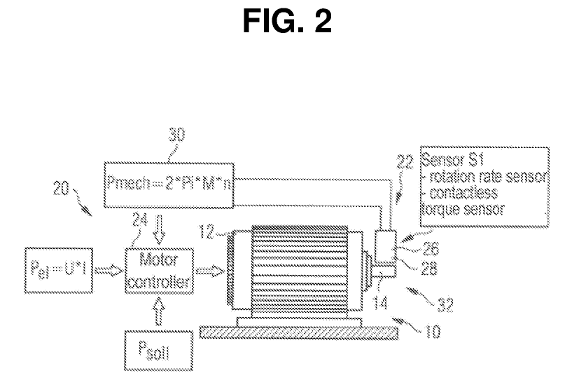

FIG. 2 shows the electric drive 10 with a torque regulating device 20. The torque regulating device 20 comprises a torque sensor assembly 22 and a control system 24 connected to the torque sensor assembly 22 in order to control the electric motor 12 in accordance with a torque M on the output shaft 14 measured by a torque sensor 26 of the torque sensor assembly 22.

Further, the illustrated torque regulating device 20 comprises a rotation rate sensor 28 for acquiring the rotation rate n of the output shaft 14.

The torque sensor assembly 22 has the torque sensor 26, an evaluation unit 30 and a rotary shaft 32, with the torque being acquired on the rotary shaft 32. In the application of the torque sensor assembly 22 shown in FIG. 2, the rotary shaft 32 is equal to the output shaft 14 of the electric drive 10.

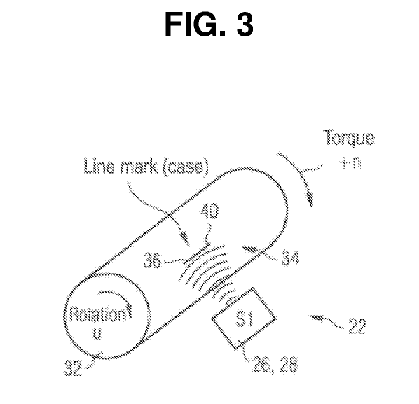

As will be explained below with reference to the illustrations of FIGS. 3 to 6, the torque sensor 26, together with the evaluation unit 30, is also configured for acquiring the rotation rate of the rotary shaft 32. For this purpose, the rotary shaft 32 has a surface mark 36 on the circumferential region 34 that rotates past the torque sensor 26.

The torque sensor 26 is configured as a contactlessly operating magnetorestrictive sensor S1 that operates with alternating magnetic fields. For more details regarding sensors of this type, reference is made to the following sources:

[1] Lutz May, ,,Drehmoment so einfach wie Temperatur messen” in Einkaufsführer Messtechnik & Sensorik 2015;

[2] Gerhard Fiedler, Franz Merold ,,Intelligente Sensorik-Magnetorestriktive Drehmomentsensoren” in Elektronik Journal 04/2016;

[3] H. Ruser, U. Tröltzsch, M. Horn, H.-R. Tränkler; ,,Magnetische Drehmomentmessung mit Low-cost Sensor” downloaded on Jun. 2, 2016, at http://www.mikrocontroller.net/attachment/22413/Drehmomentsensor-Kreuzspule.pdf; Lecture VDE/VDI conference Mar. 11 and 12 2002, Ludwigsburg, also see references in this document;

[4] WO2015/001097 A1.

Such sensors S1 are available, for example, from the company Torque and More GmbH, Starnberg.

The sensor S1 is preferably configured to be contactless, based on the inductive measuring principle, see [3], [2]. As explained in [4], the sensor S1 is operated with an alternating magnetic field. In this case, an operation in an active mode is advantageous; in this way, the fast alternating magnetic field requires no physical change to the rotary shaft 32, a permanent magnetization, which may possibly not be stable in the long term, is not required, see [1]. The method is impervious to contamination (water, oil, dust), vibration, change of the air gap and also cannot be damaged if forces that are too large act on the rotary shaft 32 because the sensor S1 is located outside the flow of forces.

At the same time, the sensor S1 is capable of acquiring several measuring quantities simultaneously:

a) In principle, S1 for measuring a torque or a force preferably operates with alternating magnetic fields between a few Hz and 10 kHz. According to the skin effect, the penetration depth for ferromagnetic materials at this frequency range is typically a few millimeters inside the material. The orientation of a transmitter and receiver coil relative to the measuring body, i.e. the rotary shaft 32, in this case determines the force component that can be measured. What is crucial for the skin effect is that the penetrating field is attenuated to a greater or lesser extent, depending on the frequency, due to the eddy currents associated with the propagation in the conductor. The current density J decreases exponentially as the distance z from the edge increases, in accordance with the following equation:

J=Jₛe^{-z/δ}

wherein Jₛ denotes the current density at the edge and δ the equivalent conducting layer thickness. These equations are used in practice for the approximate calculation also for radially symmetrical conductors. In many cases, the conducting layer thickness can be described in approximation with the following equation for good conductors:

$$δ = \sqrt{\frac{2 ρ}{ωμ}}$$

wherein:

ρ the specific resistance of the conductor; this is the reciprocal of the electrical conductivity σ of the material: ρ=1/σ;

ω angular frequency; and

μ absolute permeability of the conductor, which is the product μ=μ₀*μᵣ of the permeability constant μ₀ and the relative permeability μᵣ of the conductor.

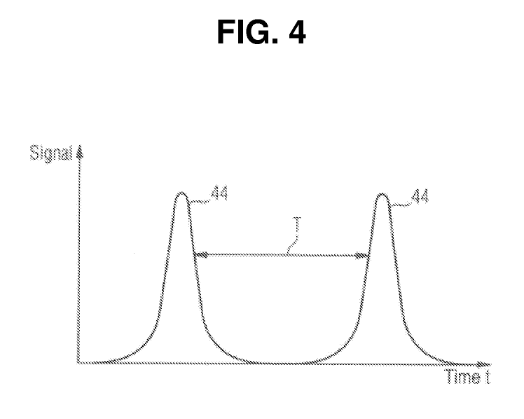

b) If a considerably higher measuring frequency is used (>10 kHz to MHz), then the magnetic field penetrates the inside of the material to a much lesser extent, and surface-sensitive effects are increasingly detected. This effect may be exploited by applying suitable marks—surface mark 36—on the shaft, for example in the form of engraved marks, e.g. a long, thin line 40 or scratch, e.g. with a thickness of 1 mm and a length of a few millimeters, which can be easily measured for each revolution. An embodiment of the surface mark in the form of the line-shaped mark is shown in FIG. 3. If the intervals of the signal pulses are evaluated, it is possible to realize a rotation rate sensor, as this is indicated in FIG. 4. The individual pulses 44 can be counted like the pulses of an incremental encoder; the intervals T between the pulses 44 is a measure for the rotation rate n (revolutions over time). The line 40 forming the surface mark 36 can be engraved very exactly into the surface of the rotary shaft 32, in particular into the surface of the output shaft 14, by means of a laser.

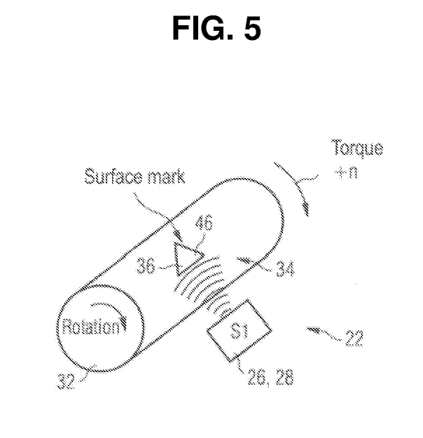

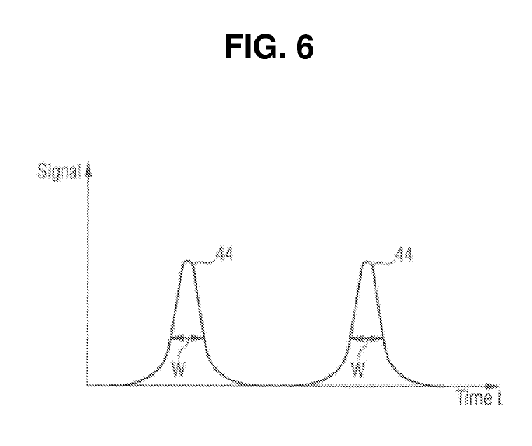

c) Given the high measuring frequency cited in b), there is also the possibility of changing the form of the engraving or embossing in such a way that not only the rotation rate n but also the rotational speed (in particular the speed of the surface of the rotary shaft in the direction of rotation) can be measured. In FIG. 5, the surface mark 36 is configured as a triangle 46. A triangular form of the surface mark 36 on the rotary shaft 32, for example, makes it possible, for example, to measure the rotational speed by measuring the pulse width W of the individual pulses 44, see FIG. 6. In general, a surface mark 36 with a defined extent in the circumferential direction is applied in this embodiment.

As was explained above, under a), b), c), a magnetorestrictive contactless sensor S1 is used while exploiting alternating magnetic fields of a higher frequency with a transmitting coil and a receiving coil, which serves both as a torque sensor 26 for acquiring the torque M of the rotary shaft 32, and in FIG. 2 of the output shaft 14 of the electric drive 10, and also as a rotation rate sensor 28 for acquiring the rotation rate n of the rotary shaft 32 and thus, in FIG. 2, of the output shaft 14 of the electric drive 10.

As is apparent in FIG. 2, the evaluation unit 30 thus provides the output torque M on the output shaft 14 as well as the rotation rate n of the output shaft 14, so that the output power P_{ab} can be determined from this.

The control system 24, which is configured as a motor controller, for example, controls the electric motor 12 in accordance with the torque M thus determined or in accordance with the output power P_{ab} thus determined. In particular, the torque M and/or the output power P_{ab} can be regulated thereby to a desired value, in particular a nominal power Pₛₒₗₗ (or a nominal torque).

Moreover, the control system 24 is able to realize both regulation and safety monitoring independent of the regulation, because of the plurality of measured quantities. For example, the electric motor 12 is regulated based on the measured values M and n or P_{ab}, and the motor input power Pᵢ is monitored by means of the motor current I and the motor voltage U for the purpose of a safety cut-out.

A preferred embodiment of a regulating device was explained above citing the example of the measurement of a torque on an output shaft. In an embodiment that is not shown in more detail, however, the torque acting between the rotor and the stator is not acquired on a component connected to the rotor, but on a component connected with the stator.

In the electric motor shown in the Figures, there is a rotating output shaft on which the torque is measured. However, many new electric motors are external rotor motors. For example, the stator is attached to an axle (shaft), which may be stationary, for example, and the power is transmitted directly via the rotor (externally) onto a wheel or a propeller.

Such a shaft which holds the stator is also suitable, in the same way as described above with respect to the output shaft, for carrying out a torque measurement.

The stator shaft or the torque sensor can also be protected against dirt in this way, so that no dust or other contamination are able to enter between the measuring element and the measuring medium.

Some electric motors available on the market have one or more Hall sensors, e.g. three Hall sensors for acquiring the exact position of the rotor. In the case of such a motor, the rotation rate may already be acquired by means of the Hall sensors. If motors of this kind are additionally equipped with a torque sensor, it is possible to acquire the torque and the rotation rate.

If the measurement on the output shaft is carried out inductively, it is advantageous to take care than the output shaft is galvanically isolated from the magnet of the motor in order to avoid the measurement being affected.

Whereas previous electric motors are configured to be rotation rate-regulated, the motors and electric machines shown here are configured to be torque-regulated.

### LIST OF REFERENCE NUMERALS

10 Electric drive
12 Electric motor (example of an electric machine)
14 Output shaft
20 Torque regulating device
22 Torque sensor assembly
24 Control system
26 Torque sensor
28 Rotation rate sensor
30 Evaluation unit
32 Rotary shaft
34 Circumferential region
36 Surface mark
40 Line
44 Pulse
46 Triangle
S1 Sensor
T Time interval/period
W Pulse width

1. A torque regulating device (20) for regulating the output power and/or the torque of an electric drive (10) having an electric motor (12) with a stator and a rotor, comprising:
a torque sensor (26) for measuring a torque produced by the electric motor and acting between the stator and the rotor, and a control system (24) which is connected to the torque sensor (26) and is configured to control the electric motor (12) in accordance with the torque measured by the torque sensor (26).

2. The torque regulating device (20) according to claim 1,
characterized by a rotation rate sensor (28) for measuring the rotation rate of the output shaft (14), the control system (24) being connected to the rotation rate sensor (28) and configured to control the electric motor (12) in accordance with the torque measured by the torque sensor (26) and the rotation rate determined by the rotation rate sensor (28).

3. The torque regulating device (20) according to claim 2,
characterized in that
the control system (24) is configured to determine the output power of the electric drive (10) from the torque and the rotation rate and to control the electric motor (12) in accordance with the determined output power.

4. The torque regulating device (20) according to claim 3,
characterized in that
the control system (24) is configured for monitoring the power output of the electric drive (14).

5. The torque regulating device (20) according to any one of the preceding claims,
characterized in that
the control system (24) is configured to control and/or monitor the electric motor (12) in accordance with an input power determined from an input current and an input voltage, and an output power determined from the torque, and a nominal power.

6. The torque regulating device (20) according to any one of the preceding claims,
characterized in that
the torque sensor (36) is an inductive contactless sensor (S1) for inductive torque detection by means of alternating magnetic fields.

7. The torque regulating device (20) according to any one of the preceding claims, characterized in that p1 the torque sensor (36) for measuring the torque is formed on a component connected to the rotor or connected to the stator.

8. The torque regulating device (20) according to claim 7,
characterized in that
the torque sensor (36), for measuring the torque, is formed on an output shaft (32) connected to the rotor and/or, for measuring the torque or a force, on a fastening component connected to the stator.

9. The torque regulating device according to any one of the preceding claims,
characterized in that
the torque sensor (26) is configured for measuring a torque on an output shaft (14) connected to the rotor by inductively measuring the torque of the output shaft (14) by means of alternating magnetic fields, and an evaluation device (30) is configured for evaluating the signal of the torque sensor (26), wherein the output shaft (14) has, on a circumferential region (34) acquired by the torque sensor (26), a surface mark (36) that rotates about the rotary axis when the output shaft (14) rotates and causes a change in the signal of the torque sensor (26) upon passing the torque sensor (26), wherein the evaluation unit (30) is configured for determining a rotation rate of the output shaft (14) from the change of the signal of the torque sensor (26).

10. The torque regulating device according to claim 9,
characterized in that
1) the surface mark (36) comprises an axially extending flattened portion, notch or raised portion on the surface of the circumferential region (34), and/or
2) that the surface mark (36) has a predefined extent in the circumferential direction, wherein the evaluation device (30) is configured for determining a rotary speed from the length of a signal change caused in the signal of the torque sensor by the surface mark (36).

11. An electric drive (10) comprising a torque regulating device (20) according to any one of the preceding claims.

12. An electric machine in the form of an electric motor or a generator, with a rotor and a stator, comprising a torque sensor for measuring a torque between the rotor and the stator, in particular for measuring a torque on a shaft connected to the rotor.

13. A method for regulating the output power and/or the torque of an electric drive (10) having an electric motor (12) with a stator and a rotor, comprising:
measuring a torque acting between the stator and the rotor by means of a torque sensor (26) and controlling the electric motor (12) in accordance with the torque measured by the torque sensor (26).

14. The method according to claim 13,
characterized by at least one, several or all of the following steps:
1) measuring the torque on an output shaft connected to the rotor,
2) measuring a force on a fastening component connected to the stator and determining the torque from the force;
3) measuring the torque on a component connected to the rotor or the stator; and/or
4) contactless inductive measuring of the torque, in particular on the output shaft (14), the fastening component or the component, by means of alternating magnetic fields.

15. The method according to any one of the preceding claims, characterized by measuring the rotation rate of the output shaft (14), and
controlling the electric motor (12) in accordance with the torque measured by the torque sensor (26) and the measured rotation rate.

16. The method according to claim 15,
characterized by determining the output power of the electric drive (10) from the torque and the rotation rate and
controlling the electric motor (12) in accordance with the determined output power.

17. The method according to claim 15 or 16,
characterized by monitoring the power output of the electric drive (10) by means of the output power, the input power determined from an input current and an input voltage, and a nominal power.

18. The method according to any one of the claims 15 to 17,
characterized by at least one, several or all of the following steps:
1) using or providing an output shaft (14) having, on a circumferential region acquired by the torque sensor (26), a surface mark (36) that rotates about the rotary axis when the output shaft (14) rotates and causes a change in the signal of the torque sensor (26) upon passing the torque sensor (26), and determining the rotation rate of the output shaft (14) from the change of the signal of the torque sensor (26), and/or
2) providing an axially extending flattened portion, notch or raised portion on the surface of the circumferential region for forming the surface mark (36); and/or
3) providing the surface mark (36) with a predefined extent in the circumferential direction, and
determining the rotary speed from the length of a signal change caused in the signal of the torque sensor (26) by the surface mark (36).
